(19) United States
(12) Patent Application Publication
(10) Pub. No.: US 2017/0087526 A1
(43) Pub. Date: Mar. 30, 2017

(54) FLUID CONDITION MONITORING USING ENERGIZED WAVE SIGNALS

(71) Applicant: SCHLUMBERGER TECHNOLOGY CORPORATION, Sugar Land, TX (US)

(72) Inventor: Rajesh LUHARUKA, Katy, TX (US)

(21) Appl. No.: 15/315,835

(22) PCT Filed: Jun. 1, 2015
(86) PCT No.: PCT/US2015/033488

§ 371 Date: Dec. 2, 2016

Related U.S. Application Data
(60) Provisional application No. 62/007,862, filed on Jun. 4, 2014.

(51) Int. Cl. B01F 15/00; G01F 23/292; G01F 23/296; G01F 23/284; B01F 7/22; B01F 3/08

(52) U.S. Cl. CPC B01F 15/00207; B01F 7/22; B01F 3/0811; B01F 3/0853; G01F 23/296; G01F 23/284; G01F 23/292; B01F 2003/0842; B01F 2003/0028

(57) ABSTRACT

Methods include providing an energized wave source integrated with a container, transmitting an energized wave from the energized wave source through a first material resident in the container, receiving by a detector a first reflected energized wave from an interfacial surface formed between a surface of the first material and a first surface of a second material, receiving by the detector a second reflected energized wave from a second surface of the second material, analyzing the first reflected energized wave and the second reflected wave to identify the first material and the second material, and determining the degree of separation of the first material and the second material. The methods may further include mixing the first material and the second material to form a homogeneous mixture, and discharging the homogeneous mixture into subterranean treatment fluid preparation process equipment.

### RELATED APPLICATION INFORMATION

This application claims the benefit of U.S. Provisional Application No. 62/007862 filed Jun. 4, 2014, which is incorporated herein in its entirety.

### FIELD

The field to which the disclosure generally relates to is measurement and monitoring chemical handling equipment, and more particularly to monitoring and ascertaining the quality of chemicals used in the preparation of fluids used in a wellbore or treating a subterranean formation in an automated setting.

### BACKGROUND

This section provides background information to facilitate a better understanding of the various aspects of the disclosure. It should be understood that the statements in this section of this document are to be read in this light, and not as admissions of prior art.

Drilling and completion of oil and gas wells involves the use of many different equipment components in a complex setting. A key element of such complex systems is the control and monitoring system. These systems generally include sensors and other elements that signal a control unit in a feedback loop. The control unit monitors the system, providing stability and ensuring the system operates within desired parameters. Sensors are often placed at specific locations within a system to provide information necessary for the control unit to function. For example, in a fracturing operation, fracturing fluid must be provided within specific parameters. Sensors monitor the flow rate of the fluid, pressure, density, viscosity and other measurables, and this information is fed back to the control unit and/or to an operator who manually monitors the system for failures. Current systems normally rely on operators to take action when failure occurs. These failures can affect job performance and lead to job failure. Also, the operators typically receive minimal feedback from the control system about its current operating state relative to its expected state. In some cases, an operator may be unaware of impending or immediate failures.

Monitoring liquid chemical materials used at a well site during an oilfield operation, such as hydraulic fracturing operation, is important for many reasons, including quality of treatment fluids being prepared with the chemical materials, as well as the overall success of the operation. Typically, chemicals are stored and consumed from large storage vessels, such as horizontal tube type transport tankers and vertical chemical containers. With thousands of gallons of chemicals in ten to fifteen different varieties being used in preparation of fluids, chemical suppliers constantly refill the containers, and it is important to monitor the inventory of materials resident in the containers in terms of quantity, identity, as well as quality. With increasing trend towards automation and reducing dependence on operators at well sites, methods and systems need to be effective to identify the chemicals, determine potential contamination that may have occurred during the container filling or refilling process, as well as any phase separation of the chemical materials, to obviate any impending or immediate failures in the oilfield operation.

Further, some chemical materials used in preparing the treatment fluids have dissolved solids therein, and some are emulsions. When stored over a period of time, these chemical materials may have a tendency of separating in the containers, which may be very difficult to detect. Hence, ensuring the mixtures have sufficient quality to in turn prepare treatment fluids of acceptable quality is key in an oilfield operation.

There exists a need for methods and systems which monitor and ascertain the condition of different chemical materials used in the preparation of well site fluids, so that conditioning steps may be taken the event that non-conformities are present, and such need is met at least in part by embodiments described in the following disclosure.

### SUMMARY

This section provides a general summary of the disclosure, and is not a necessarily a comprehensive disclosure of its full scope or all of its features.

In a first aspect of the disclosure, methods include providing an energized wave source integrated with a container, transmitting an energized wave from the energized wave source through a first material resident in the container, receiving by a detector a first reflected energized wave from an interfacial surface formed between a surface of the first material and a first surface of a second material, receiving by the detector a second reflected energized wave from a second surface of the second material, analyzing the first reflected energized wave and the second reflected wave to identify the first material and the second material, and determining the degree of separation of the first material and the second material. The methods may further include mixing the first material and the second material to form a homogeneous mixture in an automated setting, and discharging the homogeneous mixture into subterranean treatment fluid preparation process equipment. The degree of separation of the first material and the second material may also be measured in situ during the mixing the first material and the second material. In some cases the first material and the second material are miscible, while in other instances, the first material and the second material are immiscible. The energized wave may be an ultrasonic wave, a sonar wave, an electro-magnetic wave, a radio wave, or a light wave.

In another aspect of the disclosure, methods include providing an energized wave source integrated with a container, transmitting an energized wave from the energized wave source to a first surface of a first material resident in the container, receiving by a detector a first reflected energized wave from the first surface of the first material, receiving by the detector a second reflected energized wave from an interfacial surface formed between a surface of the first material and a first surface of a second material, receiving by the detector a third reflected energized wave from a second surface of the second material, analyzing the first reflected energized wave and the second reflected energized wave to identify the first material and the second material, and to determine the degree of separation of the first material and the second material, and analyzing the first reflected energized wave, the second reflected energized wave and the third reflected energized wave to ascertain volumes of the first material and the second material resident in the container. The methods may further include mixing the first material and the second material to form a homogeneous mixture in an automated setting, and discharging the homogeneous mixture into subterranean treatment fluid preparation process equipment.

Yet another aspect provides methods which involve providing a container with at least one tube vertically disposed therein, where an energized wave source and a detector are connected with the at least one tube, and an energized, such as a guided wave radar, is transmitted through the tube along each of a plurality of layers of material resident in the container. A reflected energized waves from the energized wave transmitted are received from each of the plurality of layers, and analyzed to identify material and level forming each of the each of the plurality of layers. The methods may be used to determine the degree of separation within the material forming the plurality of layers, or even ascertaining the volumes of separate materials resident in the container. The methods may further include mixing the plurality of layers to form a homogeneous mixture in an automated setting, and discharging the homogeneous mixture into subterranean treatment fluid preparation process equipment.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies and methodologies described herein, and:

FIG. 1 illustrates an apparatus in cross section view, which is useful in some methods in accordance with an aspect of the disclosure;

FIG. 2 depicts another apparatus in cross section view, which is useful in some methods in accordance with the disclosure;

FIG. 3 illustrates in a cross section view horizontal containers which may be disposed on a mobile platform which are used in some methods in accordance with some aspects of the disclosure;

FIG. 4 depicts in a cross section view use of at least one tube vertically disposed within a container, where an energized wave source and a detector are connected with the tube, which is useful in some method according to an aspect of the disclosure; and,

FIG. 5 illustrates a scenario where methods according to the disclosure are used to prepare wellbore fluids with improved and more reliable properties in an automated arrangement.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability of the disclosure.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

Embodiments according to the disclosure utilize energized wave technologies integrated with, or otherwise attached to, a material container to detect the type of chemical or chemicals, as well as potentially ascertain any separation of chemicals resident in the container. Some improvements provided by embodiments of the disclosure include detection of material quality, material quantity and/or separation of a plurality of materials used in preparing subterranean formation treatment fluids, in an automated setting at a remote well site. However, the container may be useful in any material/chemical processing scenario where chemicals are stored and consumed from large storage containers such as horizontal tube type transport containers, and vertical chemical containers. As used herein, the terms “automated” or “automation” means techniques, methods, or systems of operating or controlling a process by highly automatic means, such as by electronic devices, reducing human intervention to a minimum and without continuous input from a human operator.

In oilfield operations, thousands of gallons of chemicals in ten to fifteen different varieties may be utilized in and operation, and the containers are being continuously refilled by third party suppliers, and chemicals resident therein discharged to prepare various well site fluids. In many cases, it is important to monitor the inventory both in terms of quantity as well as quality of the materials in the container, as well as detect which chemical composition is being stored in each container. Embodiments of the disclosure enable automation thus reducing dependence on operators at well sites, and the systems are sufficiently reliable and accurate to detect the chemicals, any potential contamination that may occur during the filling refilling process, and phase separation of the chemicals. Some of the chemicals used have dissolved solids and/or are emulsions, which when unused over period of time between operations, may separate in the containers, which a condition which is difficult to detect by human monitoring, but is easily and automatically detected by embodiments according the disclosure. Embodiments of the disclosure provide benefits to an operation by introducing a system which monitors and tracks the condition of different chemicals so that mitigation methods may be instituted in the even a non-conformity exists with the chemicals resident in the containers.

In principle, as an energized wave pulse is transmitted into a medium (such as air) it travels through a medium until it comes upon a sudden change in the medium property, such as density for ultrasonic sensor, dielectric constant for electromagnetic waves, or color or optical properties for light or polarized light. The wave incident on the surface of the new medium then undergoes phenomena such as reflection, transmission and absorption. A portion of the wave is reflected and the remainder transmitted into the new medium. The reflectivity and transmissibility together adds up to one. The amplitude of wave reflection depends upon the new medium property and the contrast between new and old medium in which the wave is traveling. Therefore by analyzing the amplitude of the wave it is possible to indirectly infer the type of material present. For example in radar electromagnetic waves, the reflectivity is a function of the dielectric constant and it is possible to distinguish between acid, base, neutral and oil based or water based chemicals. Finer distinguishing may be made depending on the resolution of the measurement being made.

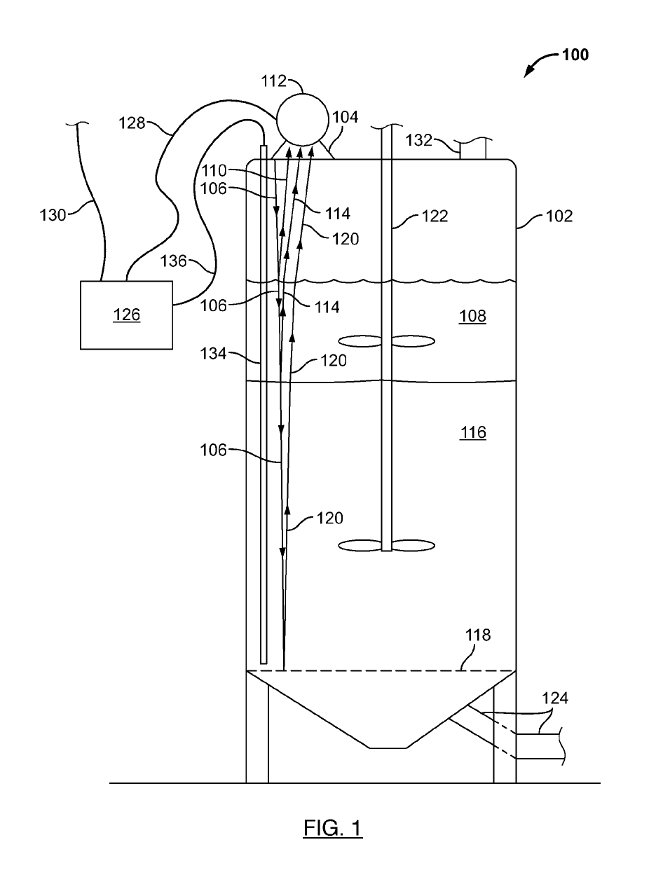

With reference to FIG. 1, an apparatus is depicted in cross section view, which is useful in some methods of the disclosure. The apparatus 100 includes container 102, which is shown as a vertical container. However, while a vertical container is shown, it is within the scope and spirit to use any applicable container shape, including vertical containers, horizontal tube transport containers, cubical totes, barrels, and the like. An energized wave source 104 is integrated with the container, shown on the top side of container 102. An energized wave 106 is transmitted from energized wave source 104 to the surface of a first material 108 resident in container 102. Upon reaching the surface of material 108, a fraction of the energized wave 106 is reflected from the surface forming reflected energized wave 110, and travels to detector 112. An angle formed between energized wave 106 and reflected energized wave 110 separates the two distinct waves, and the position upon which reflected energized wave 110 is received by detector 112 may be indicative of the surface level of material 108 within container 102. In some cases, the distance travelled by reflected energized wave 110, and hence the time elapsed from initial transmittance of energized wave 106 to surface of material 108, and reflected back to detector 112 as energized wave 110, is directly proportional to the position of the surface of material 108 within container 102. This value may be used to ascertain the overall uppermost surface position of material resident in container 102.

As the energized wave moves into material 108, it not only slows, but the wavelength changes and becomes shorter in the denser medium 108. The frequency of the energized wave does not change as it moves into material 108, the energized wave's 106 speed v in material 108 is related to both the frequency f and the wavelength I, and is the product thereof:

v=I·f 1)

Combining the above expression 1) for velocity with the definition of index of refraction, a relationship between the wavelength I=v/f in material 108 and the wavelength I₀=c/f before entering material 108 can be solved and expressed as ‘n’:

$$\frac{{λ}_{0}}{λ} = \frac{o / f}{v / f} = \frac{fo}{fv} = \frac{o}{v} = n \qquad 2 )$$

In the above equation, the frequencies cancel since frequency does not change as the energized wave 106 moves into material 108. The value n is indicative of the identity of material 108, and in the case of a mixture of materials, the state of quality of the mixture.

To illustrate how value n may be effectively used in embodiments according to the disclosure, as energized wave 106 moves through first material 108 and to an interfacial surface formed between a second surface of the material 108 and a first surface of a second material 116, a second reflected energized wave 114 is produced. The second reflected energized wave 114 travels through material 108, into the area above the surface of material 108 surface of material 108, and received by the detector 112. The value of n is related to wavelength (λ) of reflected energized wave 114, and thus indicative of the identity of material 108. Further, the distance travelled by reflected energized wave 114, as well as the time elapsed from initial transmittance of energized wave 106 to the interfacial surface formed between a second surface of the material 108 and a first surface of a second material 116, and the time for reflected energized wave 114 travel to detector 112, is directly proportional to the position of the upper surface of material 116 within container 102. This distance/time value may be used to ascertain the level and volume of material 108 resident in container 102.

Further, as illustrated in FIG. 1, a portion of energized wave 106 then moves through second material 116 and then to the bottom of container 102, or a reflective surface 118 disposed therein. A third reflected energized wave 120 is then formed, which travels through second material 116, through first material 108, and then to, and received by, detector 112. As energized wave 106 moves through second material 116 another wavelength (A) is formed, and thus value n, which is specific to and indicative of the identification of second material 116. Additionally, the distance travelled by reflected energized wave 120, as well as the time elapsed from initial transmittance of energized wave 106 to the bottom of container 102, or a reflective surface 118 disposed therein, and the time for reflected energized wave 120 travel to detector 112, is directly proportional to the overall volume of materials within container 102, when compared to the position of the surface of material 108. Further, this distance/time value may be used to ascertain the level and volume of material 116 resident in container 102 by subtraction of the level or volume of material 108.

Upon determining the relative quantities and identification of materials 108 and 116, the materials may be appropriately conditioned, as necessary, before being discharged into a process stream. For example, if materials 108 and 116 are phase separated, mixing may be imparted into the materials by rotating mixing blade 122 to impart adequate energy to form a homogeneous mixture. Mixing blade 122 may be rotated by any suitable device known to those of skill in the art. Throughout the mixing, the condition of the mixture formed, may be monitored in situ by transmitting energized wave 106 from the wave source 104 into the mixture, and receiving a reflected energized wave at detector 112 which has traveled through the mixture. When a targeted wavelength (λ), and thus value for n has been achieved which represents a quality of mixture, the mixture may be discharged from discharge conduit 124 into a greater material processing arrangement, such as a batch mixing or continuous mixing process. In the case of well site materials, the mixture may be introduced into a subsequent mixer or disperser used for preparing a subterranean formation treatment fluid, such as a drilling fluid, fracturing fluid, gravel packing fluid, matrix acidizing fluid, cleanout fluid, and the like. Further, during the discharge of material from container 102 and into the material processing arrangement, the decreasing level of the mixture can be continually monitored by transmitting energized wave 106 from the wave source 104 to the surface of the mixture, and receiving a reflected energized wave at detector 112, to measure and ensure a rate of discharge of the mixture into the material processing arrangement.

Referring again to FIG. 1, in some embodiments of the disclosure, the system of components used in methods may be integrated with a controller 126 which may be a computer, microprocessor, or PLC, which enables automation of the system. Automation of the system may obviate the requirement for operators to make physical measurements and visual observations to determine levels, identification and quality of material resident in container 102. In operation, controller 126 is connected to transmitter 104 and detector 112 by a suitable conductor 128, which is capable of controlling the characteristics of energized wave 106 as well as receiving signals corresponding with detected reflected energized waves, such as 110, 114 and 120. In some aspects, as controller 126 receives signals indicating the materials in container 102 require action, such as mixing, controller 126 controls a motor (not shown) through conductor 130 which rotates mixer 122 to condition the material for effective use in a greater material processing arrangement, and to prepare an improved quality material. This can be achieved in an automatic scenario where the signals received from the detector are compared with a correlation curve and mixing is automatically initiated until the signals received correspond with a target wavelength (A) or value n for the mixture homogenized. The net effect is improved performance of the materials mixture in a final product where human operator input is not present. While conductors are shown for connecting controller 126 to various components of the apparatus, any suitable technique of data communication known to those of skill in the art may be used in embodiments of the disclosure, including local area wireless communication, radio communication, optical communication, and the like.

In yet another aspect of the disclosure, transmitter 104 generating energized waves and detector 112 receiving reflected energized waves, may be used for monitoring one or more materials introduced, or otherwise filled, into container 102, through an inlet port 132. A material, such as 108, may be introduced into the container, and during the fill, energized wave 106 and reflected energized wave 110 may generate a signal indicative of the level of material 108 resident in container 102. Utilizing controller 126, the filling of the material may continue or be held when a target level of material is introduced into the container. Further, in conjunction with discharging a mixture from container 102, the controller can signal for replenishment of materials into the container through inlet 132.

Electronic level sensors may be integrated into some apparatus useful in some methods of the disclosure. An electronic level sensor 134 may be affixed to the interior of container 102. Levels may be measured under static conditions, or continuous measurements while material is being added into or discharged from the container 102. Some exemplary level sensor methods for measurement of the content of material include: ultrasonic level sensors operating on the principle of sound wave transmission and reception, where high frequency sound waves from a transmitter are reflected by the top surface of the content to a receiver, and the height of the material; radar level sensors operating on the principle of electromagnetic wave transmission and reception where electromagnetic waves from a transmitter are reflected by the top surface of the content to a receiver, and the height of the content is inferred from the round-trip travel time; or capacitance sensors measuring the capacitance between two metallic rods or between a metallic rod and the ground, where the silo content has a different dielectric constant than air, and the capacitance changes according to the level of the top surface of the content between the two rods or between a rod and the ground. The electronic level sensor 134 may be integrated with controller 126 via conductor 136 as part of the overall automation and control of the apparatus.

In embodiments of the disclosure, materials identified and analyzed, such as materials 108 and 116 depicted in FIG. 1, may be any material capable of such detection and analysis by energized wave. Some non-limiting examples include single phase liquids, multiphase liquids such as emulsions, salt solutions, acid solutions, base solutions, slurries of a liquid phase and particulate, polymer solutions, polymer suspensions, surfactant suspensions, and the like.

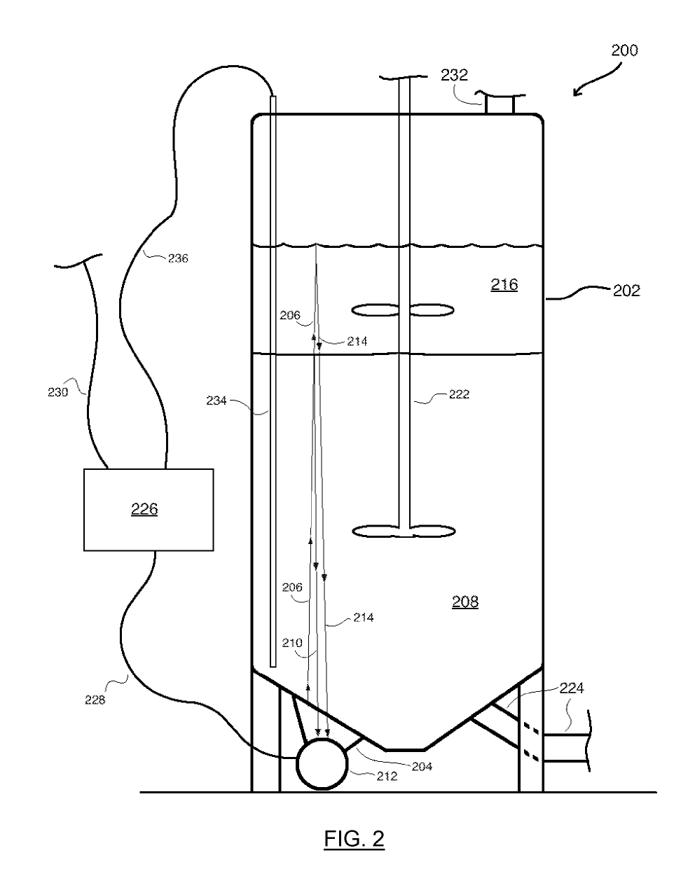

FIG. 2 illustrates another apparatus, depicted in cross section view, which is useful in some methods of the disclosure. The apparatus 200 includes container 202, and an energized wave source 204 is integrated with the container, shown on the bottom side of container 202. Detector 212 is configured integrated with source 204. Energized wave 206 is transmitted from energized wave source 204 through a first material 208 resident in container 202. Upon reaching the upper surface of material 208, a fraction of the energized wave 206 reflects from the surface forming reflected energized wave 210, then travels to detector 212. The angle formed between energized wave 206 and reflected energized wave 210 separates the two distinct waves, and the position upon which reflected energized wave 210 is received by detector 212 may be indicative of the surface level of material 208. In some cases, the distance travelled by reflected energized wave 210, and thus the time elapsed from initial transmittance of energized wave 206 to surface of material 208, and reflected back to detector 212 as energized wave 210, is directly proportional to the position of the surface of material 208 within container 202. The value of n is related to wavelength (A) of reflected energized wave 210 and is indicative of the identity of material 208.

A portion of energized wave 206 then moves through second material 216 and to the upper surface the second material 216, where a second reflected energized wave 214 is produced. The second reflected energized wave 214 travels through material 216, into material 208, and is received by the detector 212. A value of n is related to wavelength (A) of reflected energized wave 214, and thus indicative of the identity of material 216. Further, the distance travelled by reflected energized wave 214, as well as the time elapsed from initial transmittance of energized wave 206 through first material 208 and the second material 216, and the time for reflected energized wave 214 travel to detector 212, is directly proportional to the position of the uppermost surface position of material resident in container 202. As such, this time and distance can be used to ascertain the overall amount of materials in container 202.

Upon determining the relative quantities and identification of materials 208 and 216 in container 202, the materials may be conditioned as necessary, before being discharged into a greater process stream. In such instances, mixing blade 222 may be rotated to impart adequate energy to form a homogeneous mixture of the materials. The condition of the mixture being formed may be monitored in situ by transmitting energized wave 206 from the wave source 204 into the mixture, and receiving a reflected energized wave at detector 212 which has traveled through the mixture. When a targeted wavelength (λ), and thus value for n has been achieved which represents a quality of mixture, the mixture may be discharged from discharge conduit 224 into a greater material processing arrangement. As described above, the mixture may be introduced into a subsequent mixer or disperser used for preparing a subterranean formation treatment fluid. Further, during the discharge of material from container 202 and into the material processing arrangement, the decreasing level of the mixture can be continually monitored by transmitting energized wave 206 from the wave source 204 to the surface of the mixture, and receiving a reflected energized wave at detector 212, to measure and ensure a rate of discharge of the mixture into the material processing arrangement.

Referring again to FIG. 2, the system of components used in methods may also be integrated with a controller 226, which may enable automation of the system thus obviating operators to make physical measurements and visual observations to determine levels, identification and quality of material resident in container 202. In operation, controller 226 is connected to transmitter 204 and detector 212 by a suitable conductor 228. Controller 226 is capable of controlling the characteristics of energized wave 206 as well as receiving signals corresponding with detected reflected energized waves, such as 210 and 214. Controller 226 may receive signals indicating the materials in container 202 require action, such as mixing, and controller 226 controls a motor (not shown) through conductor 230 to which rotates mixer 222 to condition the material for effective use. This can be achieved in an automatic scenario where the signals received from the detector are compared with a correlation curve and mixing is automatically initiated until the signals received correspond with a target wavelength (λ) or value n for the mixture homogenized. The net effect is improved performance of the materials mixture in a final product where human operator involvement is not present.

In some aspects, transmitter 204 generating energized waves and detector 212 receiving reflected energized waves, may be used for monitoring one or more materials introduced, or otherwise filled, into container 202, through an inlet port 232. A material, such as 216, or 208, may be filled into the container, and energized wave 206 and reflected energized wave 214, or 210, may generate a signal indicative of the level of material 216, or 208, resident in container 202. Utilizing controller 226, the filling of the material may continue or be held when a target level of material is introduced into the container. Further, in conjunction with discharging a mixture from container 202, the controller can signal for replenishment of materials into the container through inlet 232. Further, similar to the embodiment described in FIG. 1, an electronic level sensor 234 may be affixed to the interior of container 202. Levels may be measured under static conditions, or continuous measurements while material is being added into or discharged from the container 202. The electronic level sensor 234 may be integrated with controller 226 via conductor 236 as part of the overall automation and control of the apparatus 200.

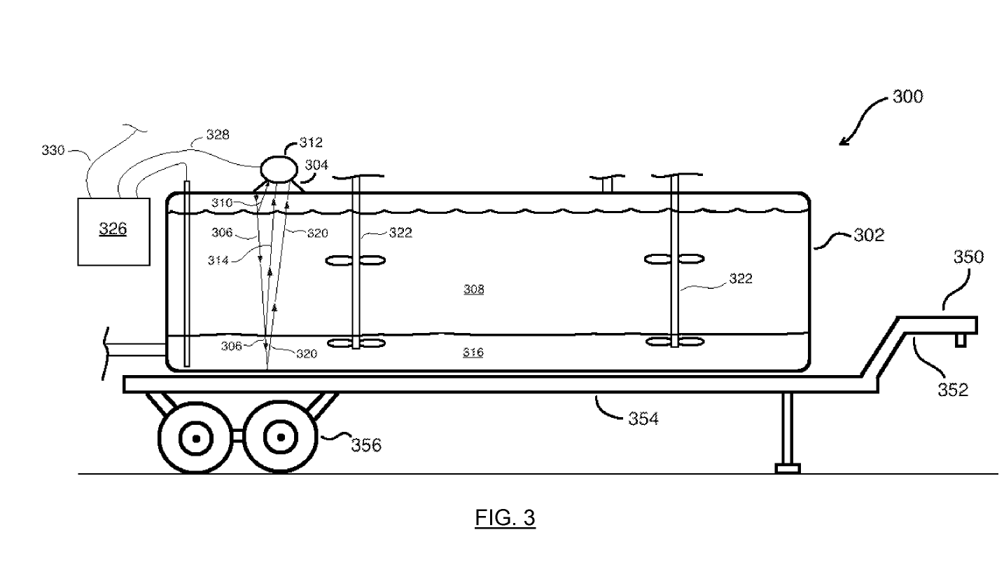

While FIGS. 1 and 2 depict containers 102 and 202 which are essentially vertical containers support on a stand, embodiments of the disclosure also include use of horizontal containers which may be disposed on a mobile platform, such as that shown in FIG. 3, which is a general representation of such an apparatus. Apparatus 300 includes horizontal oriented container 302 disposed on trailer 350. Trailer 350 may include the typical components known for mobile transport of materials, such as gooseneck 352, frame 354, wheels 356, and the like, for moving materials from one location to another. Container 302 includes an integrated energized wave source 304 and detector 312. Energized wave 306 is transmitted from source 304 to the surface of a first material 308, and upon reaching the surface of material 308, a fraction of the energized wave 306 is reflected from the surface forming reflected energized wave 310, and travels to detector 312. The position upon which reflected energized wave 310 is received by detector 312 may be indicative of the surface level of material 308 within container 302. The distance travelled by reflected energized wave 310, and hence the time elapsed from initial transmittance of energized wave 306 to surface of material 308, and reflected back to detector 312 as energized wave 310, is directly proportional to the position of the surface of material 308. This value may be used to ascertain the overall uppermost surface position of material resident in container 302.

A portion of energized wave 306 then moves through first material 308 to an interfacial surface formed between a second surface of the material 308 and a first surface of a second material 316. A second reflected energized wave 314 is generated at the interfacial surface, which then travels through material 308, into the area above the surface of material 308, and received by the detector 312. The value of n is related to wavelength (A) of reflected energized wave 314, and thus indicative of the identity of material 308. The distance travelled by reflected energized wave 314, and time elapsed from initial transmittance of energized wave 306 to receiving reflected energized wave 314 at detector 312, is indicative of the level and volume of material 308 resident in container 302. Another portion of energized wave 306 moves through second material 316 and then to the bottom of container 302. A third reflected energized wave 320 is then formed, which travels through second material 316, through first material 308, and then to detector 312. As energized wave 306 moves through second material 316 another wavelength (λ) is formed, and thus value n, which is specific to and indicative of the identification of second material 316.

Some components of apparatus 300 are integrated with a controller 326, enabling automation of the system for identification and quality of material resident in container 302. Controller 326 is connected with transmitter 304 and detector 312 by conductor 328. Controller 326 is capable of controlling the characteristics of energized wave 306 as well as receiving signals corresponding with detected reflected energized waves, such as 306, 314 and 320. Controller 326 may receive signals indicating the materials in container 302 require action, such as mixing, and controller 326 controls rotation of mixers 322 to condition the material. This is achieved in an automatic scenario where the signals received from the detector are compared with a correlation curve and mixing is automatically initiated until the signals received correspond with a target wavelength (λ) or value n for the mixture homogenized.

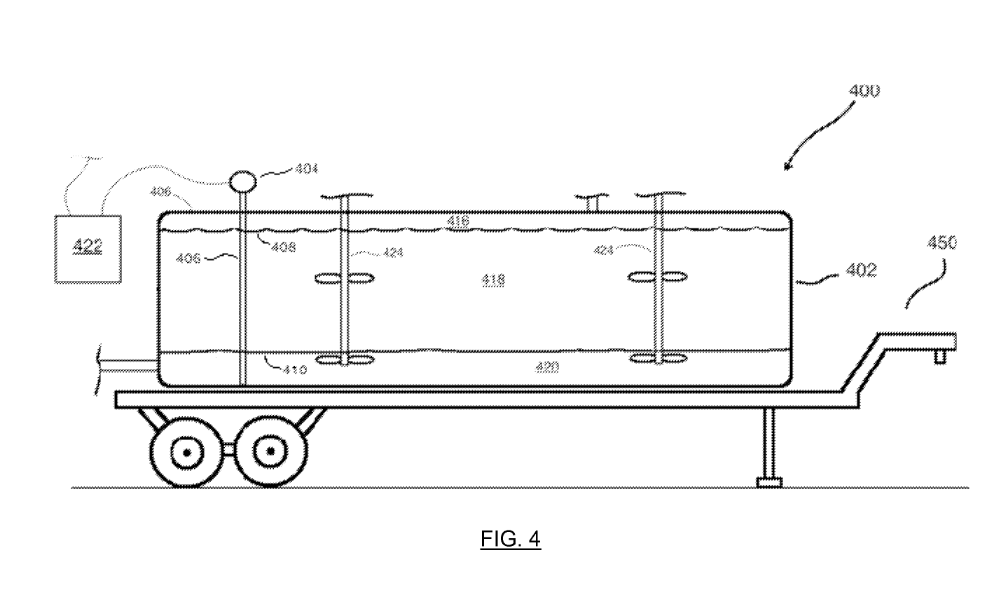

In another embodiment of the disclosure, a method includes use of at least one tube vertically disposed a container, where an energized wave source and a detector are disposed within the at least one tube or stilling well. With reference to FIG. 4, apparatus 400 used according to the method includes a horizontal container 402 mounted on a trailer 450, but could be any practical container shape or size. Container 402 includes an integrated energized wave source and detector 404 with a tube 406 disposed in container 402. An energized wave, such as guided wave radar, is transmitted from source 404 longitudinally through tube 406, and portions of the energized wave are reflected back to the integrated energized wave source and detector 404. Energized wave 406 travels along the first medium 416, and the initial wavelength of energized wave 406 may or may not be altered by first medium 416. The wavelength of the detected reflected energized wave 406 may be indicative of the identity of first medium 416. Upon reaching the interface 408 of first medium 416 and another material 418, a reflected signal is generated and received by the integrated energized wave source and detector 404, which indicates the surface position or level of material 418 in container 402.

A portion of the energized waves travels further through tube 406 along material 418, and the wavelength of the detected reflected energized waves may be used to identity material 418. At interface 410 of material 418 and another material 420, a reflected signal is generated and received by the integrated energized wave source and detector 404, indicative of the surface position material 420 in container 402. A portion of the transmitted energized wave 412 then travels further through tube along material 420, and the wavelength of a detected reflected energized wave may be used to identity material 420.

Components of apparatus 400 may be integrated with a controller 422, enabling automation of the system for identification and quality of material resident in container 402. Controller 422 is connected with integrated energized wave source and detector 404 and is capable of controlling the characteristics of the energized wave transmitted as well as receiving signals corresponding with detected reflected energized waves. Controller 422 may receive signals indicating the materials in container 402 require action, such as mixing, and controller 422 controls rotation of mixers 424 to condition the material. This is achieved in an automatic scenario where the signals received from the detector are compared with a correlation curve and mixing is automatically initiated until the signals received correspond with a target wavelength (λ) or value n for the mixture homogenized. Upon ascertaining the degree of separation, the plurality of layers may be mixed to form a homogeneous mixture, and then discharged into fluid preparation equipment, such as subterranean treatment fluid preparation process equipment.

In yet other embodiments, instead of analyzing the fluid by sending an energized wave from a source disposed inside the container, the waves may be coupled into the medium externally through the container walls. In such embodiments, long range waves such as sonar or geophones may be utilized to send the energized waves through multiple layers and reflect back to a detector to provide useful composition and interface properties. Some other method embodiments employ externally disposed energized wave sources and detectors to ascertain chemical type, condition and level which are based upon capacitive/electromagnetic sensors. In such cases, multiple electrodes may be wrapped around the container and used to detect the local capacitance through the container wall and into the fluid medium. A change in capacitance enables the detection of the chemical, and its characteristics for identification. Similarly, an electromagnetic flux may be coupled from outside the container to detect the variation in the properties of the medium inside the container.

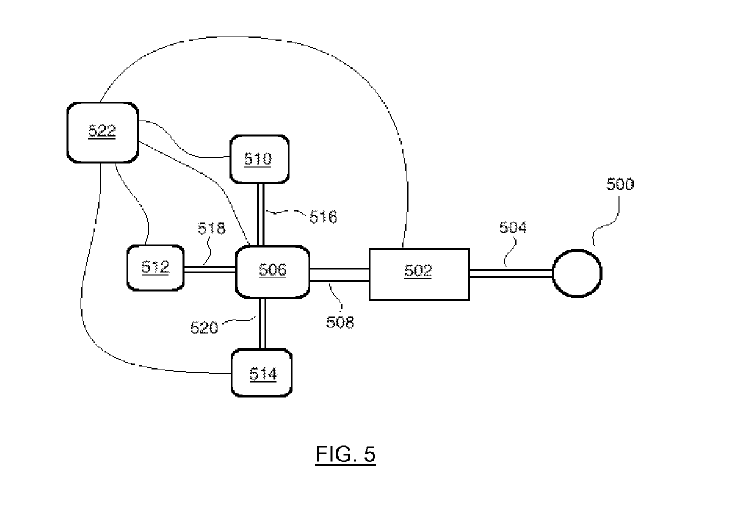

In an oilfield well site setting, methods according to the disclosure may be useful for preparing fluids for drilling, fracturing, gravel packing, matrix acidizing, cleanout, and the like. FIG. 5 depicts such a scenario where apparatus such as those described above are used to prepare wellbore fluids with improved and more reliable properties in an automated arrangement. In general, a wellbore 500 is fluidly connected with a fluid pressurizing pumping system 502 by pipe 504. The fluid pressurizing pumping system 502 may be any pump system known to those of skill in the art, for delivering the particular type of fluid into the wellbore at target pressure. Fluid pressurizing pumping system 502 is fluidly connected to mixing system 506 by pipe 508. Connected to mixing system 506 are one or more material containers 510, 512 and 514 by conduits 516, 518 and 520, respectively. While three material containers are shown, any suitable number of containers may be connected with the mixing system 506. Each of material containers 510, 512 and 514 include an energized wave source and detector used in an automated scheme, as described above, to identify, quantify and condition materials as necessary resident in containers 510, 512 and 514. The energized wave source and detector are connected with central controller 522, which may be used for monitoring and ensuring the quality and quantity of materials without dependence on physical observations of materials resident in the containers by human operators.

Central controller 522 may be further integrated and connected with mixing system 506 and fluid pressurizing pumping system 502 to monitor characteristics and properties of the fluid being prepared, as well as monitoring and controlling fluid pressure as the treatment fluid is introduced into the wellbore 500. In some instances, if the characteristics of the fluid being prepared are not within target specifications, central controller 522 may detect which material in which container may be the source of the noncompliant issue. Fluid preparation may be halted, the material conditioned for use, and fluid preparation, and subsequent pumping resumed. Alternatively, all materials may be preconditioned prior to use in preparing and pumping the fluid. In each case, improved fluid properties are the net result of the process.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A method comprising:
a) providing an energized wave source integrated with a container;
b) transmitting an energized wave from the energized wave source through a first material resident in the container;
c) receiving by a detector a first reflected energized wave from an interfacial surface formed between a surface of the first material and a first surface of a second material;
d) receiving by the detector a second reflected energized wave from a second surface of the second material;
e) analyzing the first reflected energized wave and the second reflected wave to identify the first material and the second material; and,
f) determining the degree of separation of the first material and the second material.

2. The method of claim 1 further comprising:
g) mixing the first material and the second material in an automated setting to form a homogeneous mixture; and,
h) discharging the homogeneous mixture into subterranean treatment fluid preparation process equipment.

3. The method of claim 2 further comprising determining the degree of separation of the first material and the second material during the mixing the first material and the second material.

4. The method of claim 2 wherein the first material and the second material are miscible.

5. The method of claim 2 wherein the first material and the second material are immiscible.

6. The method of claim 5 wherein the homogeneous mixture is an emulsion.

7. The method of claim 1 wherein the energized wave is an ultrasonic wave, a sonar wave, an electro-magnetic wave, a radio wave, or a light wave.

8. The method of claim 1 wherein the container further comprises a level sensor disposed therein.

9. The method of claim 8 wherein the level sensor is an acoustic sensor, a radar sensor, or an optics based sensor.

10. A method comprising:
a) providing an energized wave source integrated with a container;
b) transmitting an energized wave from the energized wave source to a first surface of a first material resident in the container;
c) receiving by a detector a first reflected energized wave from the first surface of the first material;
d) receiving by the detector a second reflected energized wave from an interfacial surface formed between a surface of the first material and a first surface of a second material;
e) receiving by the detector a third reflected energized wave from a second surface of the second material;
f) analyzing the first reflected energized wave and the second reflected energized wave to identify the first material and the second material, and to determine the degree of separation of the first material and the second material; and,
g) analyzing the first reflected energized wave, the second reflected energized wave and the third reflected energized wave to ascertain volumes of the first material and the second material resident in the container.

11. The method of claim 10 further comprising:
h) mixing the first material and the second material in an automated setting to form a homogeneous mixture; and,
i) discharging the homogeneous mixture into subterranean treatment fluid preparation process equipment.

12. The method of claim 11 further comprising determining the degree of separation of the first material and the second material during the mixing the first material and the second material.

13. The method of claim 11 wherein the first material and the second material are miscible.

14. The method of claim 11 wherein the first material and the second material are immiscible.

15. The method of claim 14 wherein the homogeneous mixture is an emulsion.

16. The method of claim 10 wherein the energized wave is an ultrasonic wave, a sonar wave, an electro-magnetic wave, a radio wave, or a light wave.

17. The method of claim 10 wherein the container further comprises a level sensor disposed therein.

18. The method of claim 17 wherein the level sensor is an acoustic sensor, a radar sensor, or an optics based sensor.

19. A method comprising:
a) providing a container with at least one tube vertically disposed therein, wherein an energized wave source and a detector are connected the at least one tube;
b) transmitting an energized wave from the energized wave source longitudinally along the length of the at least one tube through each of a plurality of layers of material resident in the container;
c) receiving a plurality of reflected energized waves from the energized wave transmitted longitudinally through the length of the at least one tube along each of the plurality of layers; and,
d) analyzing each of the reflected energized waves to identify material forming each of the each of the plurality of layers.

20. The method of claim 19 further comprising determining the degree of separation within the material forming the plurality of layers.

21. The method of claim 20 further comprising ascertaining volume of separate materials resident in the container.

22. The method of claim 20 further comprising:
e) mixing the plurality of layers to form a homogeneous mixture in an automated setting; and,
f) discharging the homogeneous mixture into subterranean treatment fluid preparation process equipment.

23. The method of claim 22 further comprising determining the degree of separation of the plurality of layers material during the mixing.

24. The method of claim 22 wherein the plurality of layers are miscible.

25. The method of claim 22 wherein the plurality of layers are immiscible.

26. The method of claim 25 wherein the homogeneous mixture is an emulsion.

27. The method of claim 19 wherein the energized wave is an ultrasonic wave, a sonar wave, an electro-magnetic wave, a radio wave, or a light wave.

28. The method of claim 19 wherein the container further comprises a level sensor disposed therein.

29. The method of claim 28 wherein the level sensor is an acoustic sensor, a radar sensor, or an optics based sensor.
